(19) United States
(12) Patent Application Publication
(10) Pub. No.: US 2026/0044341 A1
(43) Pub. Date: Feb. 12, 2026

(54) Data Processing Device and Method for Processing Secret Data

(71) Applicant: Infineon Technologies AG, Neubiberg (DE)

(72) Inventors: Vinayaka Belavadi Ranganatha, Augsburg (DE); Tim Fritzmann, Kissing (DE); Stefan Heiss, Bobingen (DE)

(21) Appl. No.: 19/289,978

(22) Filed: Aug. 4, 2025

(30) Foreign Application Priority Data
Aug. 12, 2024 (DE) 102024207660.0

(51) Int. Cl. G06F 9/30; H04L 9/06

(52) U.S. Cl. CPC G06F 9/30038; H04L 9/0643

(57) ABSTRACT

A data processing device comprises a round mask generator, a controller configured to control values and a processor configured to iteratively process a vector of values, where each iteration comprises receiving a respective input vector, generating a processing result vector by applying a predefined processing algorithm to the input vector, and, in reaction to that the control value associated with the iteration indicates that the iteration is a dummy iteration, outputting the input vector re-masked with the round mask associated with the next iteration of the sequence of iterations and, in reaction to that the control value associated with the iteration indicates that the iteration is a real iteration, generating a masked processing result vector by masking the processing result vector with the round mask associated with the next iteration and outputting the masked processing result vector.

### TECHNICAL FIELD

The present disclosure relates to data processing devices and methods for processing secret data in such devices.

### BACKGROUND

Hash functions are among the fundamental cryptographic primitives used in today's applications. They are used in variety of purposes like verifying integrity, digital signatures, message authentication codes (MACs), blockchain technology etc.

While the National Institute of Standards and Technology (NIST) has standardized different hash algorithms like SHA1 (FIPS 180-1), SHA2 (FIPS 180-2) and SHA3 (FIPS 202), actual implementations of these and other algorithms may be prone to attacks like logical attacks and side-channel attacks (SCA). In a typical side-channel attack, the attacker exploits the information leaked by hardware during the execution of the cryptographic algorithm to extract sensitive data. The information may be leaked in the form of power consumption, electromagnetic emissions, etc. Hence, additional countermeasures are needed in the hardware or software implementation of the hash algorithm so that correlations between the sensitive data and the leaked side-channel information are minimized.

Some of the methods used for protecting a hash implementation against SCAs are:
a) Sensitive data is randomly split and then processed in multiple shares while executing the hash algorithm. By using such random shares, correlation between the sensitive data and the leaked side-channel information is reduced.
b) Using a hiding concept based on dummy block operations.
c) Using a hiding concept based on dummy rounds within each block operation.

Dummy round iterations may be executed in loop operations of hash compression functions and different output buffers are used for real and dummy rounds. For example, the loop in the SHA512 compression function is executed 112 times instead of 80 times. The additional 32 times are dummy operations whose results are discarded.

Even though the above approaches provide additional hardening against SCA, they are not sufficient against sophisticated attacks. Potential attack paths and disadvantages are, for example:
a) the attacker being able to distinguish real and dummy round iterations based on whether the real output buffer or the dummy buffer is used or round constant table lookups.
b) the static data in shares being insufficient on some hardware, particularly when higher order attacks are considered.
c) an increase of the execution time or circuit size due to measures for the reduction of output buffer leakages, e.g., with an additional hiding layer and random buffer swaps. Further, such techniques are prone to additional security vulnerabilities.

Accordingly, effective approaches against attacks (i.e., approaches to reduce exploitable side-channel information leakage) on electronic devices that execute algorithms for processing sensitive data that needs to be secured, such as hash algorithms, are desirable.

### SUMMARY

According to various embodiments, a data processing device is provided, comprising a round mask generator configured to provide a sequence of round masks, wherein each round mask of the sequence of round masks is associated with a respective iteration of a sequence of iterations, and a controller configured to generate a sequence of control values. Each control value of the sequence of control values is associated with a respective iteration of the sequence of iterations and indicates, for the respective iteration, whether the iteration is a real iteration or a dummy iteration and a processor, configured to process a vector of values in the sequence of iterations. Each iteration comprises:
receiving a respective input vector
generating a processing result vector by applying a predefined processing algorithm to the input vector
in reaction to the control value associated with the iteration indicating that the iteration is a dummy iteration, outputting, as an output vector of the iteration, the input vector re-masked with the round mask associated with the next iteration of the sequence of iterations, and
in reaction to the control value associated with the iteration indicating that the iteration is a real iteration, generating a masked processing result vector by masking the processing result vector with the round mask associated with the next iteration and outputting the masked processing result vector as the output vector of the iteration.

It should be noted also that, in a dummy iteration, the processing result vector is generated, which is, in case of a dummy iteration, a dummy result.

According to other embodiments, a method for processing secret data according to the above data processing device is provided.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an example for a processing device.

FIG. 2 shows a processing block for carrying out a real hash kernel round or a dummy hash kernel round.

FIG. 3 shows a data processing device according to an embodiment.

FIG. 4 shows a flow diagram illustrating a method for processing secret data.

### DETAILED DESCRIPTION

The following detailed description refers to the accompanying drawings that show, by way of illustration, specific details and aspects of this disclosure in which the invention may be practiced. Other aspects may be utilized, and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

The embodiments described herein can be realized in or with a processing device like a personal computer, microcontroller, smart card (of any form factor), secure microcontroller, hardware root of trust, (embedded) secure element (ESE), Trusted Platform Module (TPM), or Hardware Security Module (HSM).

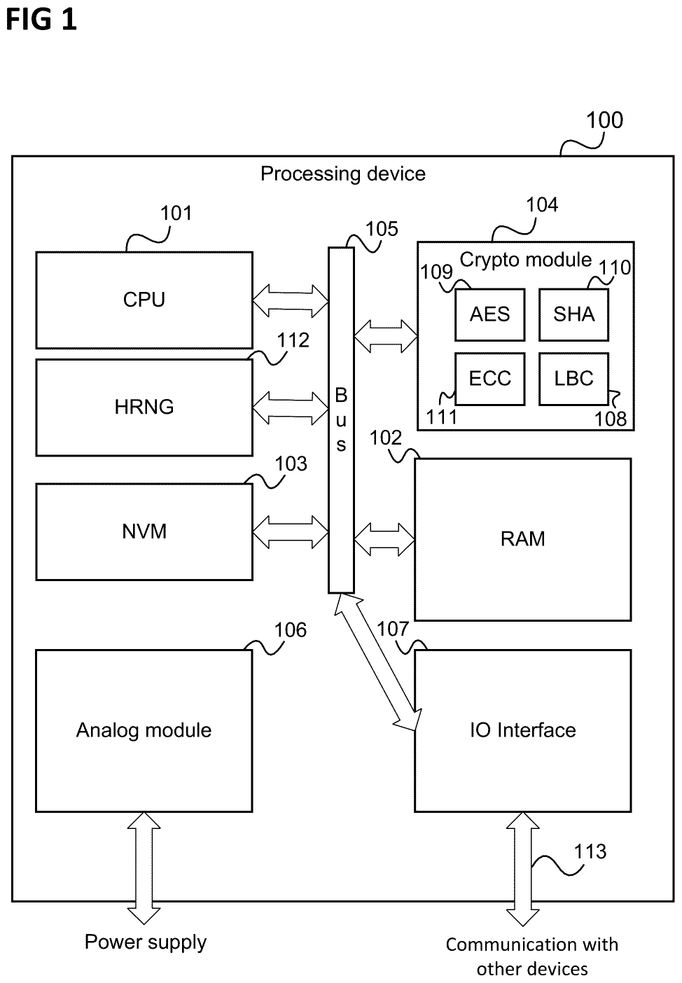

FIG. 1 shows an example for a processing device 100 including a CPU 101, a RAM 102, a non-volatile memory (NVM) 103, a crypto module 104, an analog module 106, an input/output interface 107 and a hardware-random number generator (HRNG) 112.

In this example, the CPU 101 has access to at least one crypto module 104 over a bus 105 to which each crypto module 104 is coupled. Each crypto module 104 may in particular include one or more crypto cores to perform certain cryptographic operations. Exemplary crypto cores are:
an AES core 109,
a SHA core 110,
an ECC core 111, and
a lattice-based crypto (LBC) core 108.

The lattice-based crypto core 108 may be provided in order to accelerate lattice-based cryptography.

The CPU 101, the hardware random number generator 112, the NVM 103, the crypto module 104, the RAM 102 and the input/output interface 107 are connected to the bus 105. The input output interface 107 may have a connection 113 to other devices, which may be similar to the processing device 100.

The analog module 106 is supplied with electrical power via an electrical contact and/or via an electromagnetic field. This power is supplied to drive the circuitry of the processing device 100 and may in particular allow the input/output interface to initiate and/or maintain connections to other devices via the connection 113.

The bus 105 itself may be masked or plain. Instructions for carrying out the processing and algorithms described in the following may in particular be stored in the NVM 103 and processed by the CPU 105. The data processed may be stored in the NVM 103 or in the RAM 102. Supporting functions may be provided by the crypto modules 104 (e.g., expansion of pseudo random data). Random numbers are supplied by the hardware-random number generator 112.

To perform the procedures described in the following, instructions may be stored in the crypto module 104 or they may be provided by the CPU 101 via the bus 105. Data may be stored locally within the crypto module 104. It is also an option that the data is temporarily stored in the RAM 102 or the NVM 103.

The processing and algorithms described in the following may exclusively or at least partially be conducted on the crypto module 104 or on the CPU 101. A processing circuit (such as crypto module 104 or CPU 101) may or may not be equipped with hardware-based security features. Such hardware-based security features could be circuits that implement countermeasures against side-channel (power) analysis or fault injection (e.g., using a laser), to avoid that an attacker gains information about secret data (such as cryptographic keys or secret user data). Such countermeasures may be realized by the use of randomness, redundant hardware, or redundant processing. In general, the goal of countermeasures is to hide the internally processed values from an attacker who is able to observe the side-channel behaviour of the processing of such values.

In the following, an approach to protect against side-channel analysis is described for a hash algorithm (SHA3 (Secure Hash Algorithm-3) in a specific example, see below) but it may also be applied to other (in particular cryptographic) algorithms handling secure data such as cryptographic keys, passwords, secret messages etc.

In SHA3, for example, there are a plurality of stages wherein in each stage, a state vector (into which a block of the input data to be hashed is “absorbed”) is processed by a permutation function. The permutation function includes a plurality of iterations referred to as hash kernel rounds.

According to various embodiments, dummy iterations are introduced in between hash kernel rounds in such a way that there is no distinction in the side-channel profile between a real and dummy round iteration.

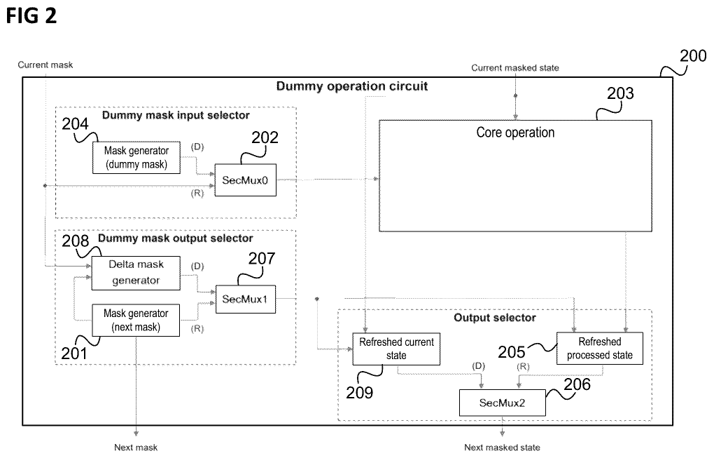

FIG. 2 shows a processing block 200 for carrying out a real hash kernel round (referred to as real round or real operation) or a dummy hash kernel round (referred to as dummy round or dummy operation) depending on a control value which indicates dummy (D) or real (R). The processing block 200 is for example implemented by a data processing device such as the processing device 100 of FIG. 1, e.g. a security controller.

As explained above, the hash kernel rounds iteratively process a state vector. Accordingly, the input of the processing block 200 is a current version of the state vector (and a current mask) and the output is a next version of the state vector (and a next mask). Both versions of the state vector are masked by a respective (round mask), i.e.
the current version of the state vector which is input to the processing block 200 is the bitwise sum (bitwise XOR) of a current plain (i.e., true or correct) state vector and a mask which is associated with the current iteration and is referred to as current round mask (or simply “current mask”). The state vector which is input to the processing block is therefore referred to as current masked state. It should be noted that the bitwise sum according to a bitwise XOR is only an example and other type of masking schemes, in particular additive masking schemes, are possible. It should further be noted that, in view of the above, masking should not be understood as suppressing individual bits of a binary representation of a value but, as explained above, representing the value as a combination of multiple random shares.
the next version of the state vector which is output by the processing block 200 is the bitwise sum (bitwise XOR) of the next plain (i.e., true or correct) state vector and a mask which is associated with the next iteration and is referred to as next mask. The state vector which is output by the processing block is therefore referred to as next masked state.

It should be noted that if the current iteration is the last iteration, the next mask is not associated with the next iteration but with the output. Depending on how the stages are implemented, it may be associated with the first iteration of the next stage or, if there is no further stage, it may be the mask of the (final) output.

The processing block 200 comprises a mask generator 201 configured to generate the next mask.

For a real operation, a first mask selector 202 (e.g., implemented by a secure multiplexer) selects the current mask (received by the processing block for the current iteration) as mask supplied to the round algorithm, i.e., a round processing block 203 which processes the current masked state taking into account the current mask such that it can generate the correct round processing result (as if operating on the plain state). In other words, the round processing block 203 computes the core operation of the round, e.g., after combining the two shares it receives (i.e., the masked current state and mask supplied to it) and generates a processed state as output. In SHA3, for example, the round processing block 203 calculates the functions Theta, Rho, Pi, Chi and Iota (e.g., using plain logic). It should be noted that the round processing block 203 may also operate on shares, i.e. the round processing block 203 does not necessarily need the unmasked data (recombined shares) for the computations, i.e., does not necessarily need to use plain logic.

For a dummy operation, the first mask selector 202 selects a dummy mask generated by a dummy mask generator 204 of the processing block 200 for the current iteration. The dummy mask is different from the current mask. Accordingly, in a dummy round, the round processing block 203 receives an incorrect mask and therefore generates an incorrect round processing result. In other words, in case of a dummy round, the combination of the current masked state and the output of the first mask selector 202 (which is the dummy mask in case of a dummy round) results in the destruction of the correct data, i.e., in an invalid state.

In both cases, a dummy round and a real round, the processed state is refreshed by a processed state refresh block 205 to a refreshed processed state. The processed state refresh block 205 refreshes (i.e., re-masks) the processed state by a mask supplied to it by a second mask selector 207.

In a real round, the second mask selector 207 supplies the processed state refresh block 205 with the next mask such that the processed state (which is the correct processed state in case of a real round) is masked with the next mask. Further, in a real round, an output selector 206 selects the output of the processed state refresh block 205 such that the processing block 200 outputs the correctly processed state masked with the next mask.

In a dummy round, the second mask selector 207 supplies the processed state refresh block 205 with the difference between the current mask and the next mask. This difference is generated by a delta mask generator 208 of the processing block 200 which receives the next mask from the mask generator 201 and the current mask (received by the processing block for the current iteration). Further, in a dummy round, the second mask selector 207 supplies the difference to a current state refresh block 209 which refreshes the current state with the mask supplied to it by the second mask selector 207. So, in a dummy round, the current state refresh block 209 changes the mask of the current masked state from the current mask to the new mask (by re-masking with the difference of these two masks). Further, in a dummy round, the output selector 206 outputs the output of the current state refresh block 209.

Accordingly, in a dummy round, the processing block 200 outputs the current state, but re-masked with the next mask instead of the current mask. In other words, a dummy round does not process the state (according to the processing algorithm for the round as defined for the hash algorithm used) but forwards it to the next round with the correct mask such that the iterative process can continue correctly.

In a real operation, the second mask selector 207 supplies the current state refresh block 209 with the next mask (e.g., to make it more difficult to detect by an attacker whether the current round is a dummy round or a real round).

It should be noted that the masks (i.e. the current mask, the next mask and the dummy mask) may be in form of a respective compressed seed and not necessarily a full mask. The respective full mask may be extracted from the respective compressed seed by a predetermined linear function (which is applied before each time the mask is used in a calculation).

The selectors 202, 206, 207 which perform a selection depending on whether the current iteration is a real round or a dummy round for example receive, in each iteration, a control value, e.g., a control bit (e.g., of a sequence of control bits having a bit for each iteration) which indicates whether the current iteration is a dummy round (D) or a real round (R) which is for example generated by a controller (not shown in FIG. 2).

So, for example, according to various embodiments, dummy round iterations are introduced into a hash kernel function (i.e., in between hash kernel rounds), wherein a dynamic round mask is provided for each (or at least each dummy) iteration. According to various embodiments, there is a single output buffer (e.g., following the output selector 206) which is updated irrespective of whether the current iteration is a real or dummy operation. The output selector 206 (e.g., implemented by a secure multiplexer) is used to select the correct output value. The new values written to the output buffer are
the same as the previous state but in a different format (i.e., differently masked) due to the iteration-specific round mask, in case of dummy round iteration
the new state (i.e., processed state) calculated, in case of a real round.

In the example of FIG. 2, the state vector is assumed to be masked. But since masking also happens by the processed state refresh block 205 or the current state refresh block 209 (i.e., at the end of the iteration), the input state may be masked with the first mask (i.e. the round mask associated with the first iteration) before starting the sequence of iterations. Also, the first iteration may always be a dummy iteration and the first mask assumed to be a trivial mask (only zeros) such that after the first iteration, the state is correctly masked with the round mask associated with the second iteration.

It should be noted that the mask generator 201 and the dummy mask generator 204 may be implemented by the same mask generator and dummy mask generator, respectively, for the iterations. In other words, the data processing device includes a mask generator and a dummy mask generator which are configured to generate a sequence of masks and a sequence of dummy masks, respectively.

It should further be noted that while the above was described for hash algorithms and SHA3 in particular, the approach described above (in particular in its more general form as described with reference to FIG. 2) may be applied to other cryptographic algorithms, in particular any hash algorithms or other cryptographic algorithms which process an input vector (the state vector in the above example) in one or more rounds.

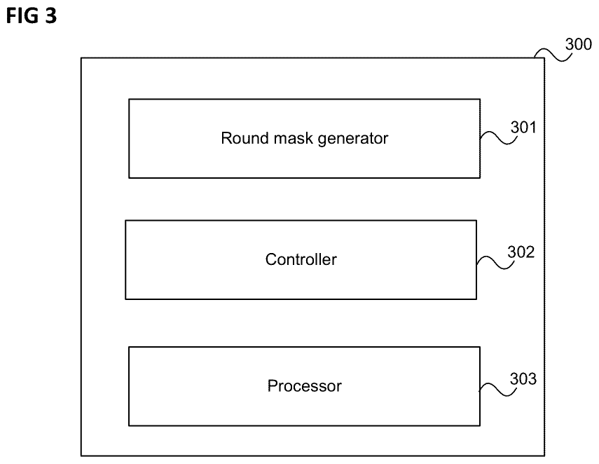

In summary, according to various embodiments, a data processing device is provided as illustrated in FIG. 3.

FIG. 3 shows a data processing device 300 according to an embodiment.

The data processing device 300 comprises a round mask generator 301 configured to provide (e.g., generate) a sequence of round masks, wherein each round mask of the sequence of round masks is associated with a respective iteration of a sequence of iterations.

The data processing device 300 further comprises a controller 302 configured to generate a sequence of control values (e.g., bits), wherein each control value of the sequence of control values is associated with a respective iteration of the sequence of iterations and indicates, for the respective iteration, whether the iteration is a real iteration or a dummy iteration.

The data processing device 300 further comprises a processor 303 configured to process a vector of values (e.g., a state vector) in the sequence of iterations, wherein each iteration comprises
receiving a respective input vector (starting from the vector of values)
generating a processing result vector by applying a predefined processing algorithm to the input vector
in reaction to the control value associated with the iteration indicating that the iteration is a dummy iteration, outputting, as output vector of the iteration (to be used as input vector for the next iteration unless the current iteration was the last iteration), the input vector (original, i.e., not processed by the processing algorithm) re-masked with the round mask associated with the next iteration of the sequence of iterations (in case the (current) iteration is the last iteration, the round mask associated with the next iteration is practically an output mask; the last iteration may in this regard be considered as a special operation not part of the sequence of iterations)
in reaction to the control value associated with the iteration indicating that the iteration is a real iteration, generating a masked processing result vector by masking the processing result vector with the round mask associated with the next iteration and outputting the masked processing result vector as output vector of the iteration (to be used as input vector for the next iteration unless the current iteration was the last iteration; as above, in case the (current) iteration is the last iteration, the round mask associated with the next iteration is practically an output mask).

It should be noted that in both dummy iterations and real operations, the processing result vector is calculated by applying the predefined processing algorithm to the input vector. In other words, the dummy iterations and the real iterations cannot be distinguished by checking whether the input vector is processed by the processing algorithm since it happens in real iterations as well as dummy iterations.

According to various embodiments, in other words, a possible distinction between real and dummy round iteration in a processing (e.g., calculating a hash, i.e., in a hash compression function) is hidden to reduce attack surface for a possible attack. According to various embodiments, this is achieved by introducing dummy rounds (e.g., in a loop operation of a hash compression function), using dynamic round masks to prevent storing values in plain and (optionally) one or more of the following:
ensuring that subfunctions have different input values in each round (including real and dummy rounds) leading to different (power) profiles.
always (i.e., for real as well as dummy rounds) updating the same output buffer independently of whether a real or dummy round is executed; in particular, a separate output buffer for dummy rounds is not needed.
accessing round constants without leaking information about the current round.

The number of dummy round iterations executed before and after real iterations may be selected randomly (e.g. for each call of the hash compression function; an example is that 24 real rounds are supplemented by 8 dummy rounds). For example, the control sequence may be determined based on a random number generator output (e.g., of random number generator 112). Similarly, the round masks and/or the dummy masks may be determined based on a random number generator output. For example, the random number output by a random number generator may be used as mask seeds from which the masks are extracted by a predetermined (linear) function.

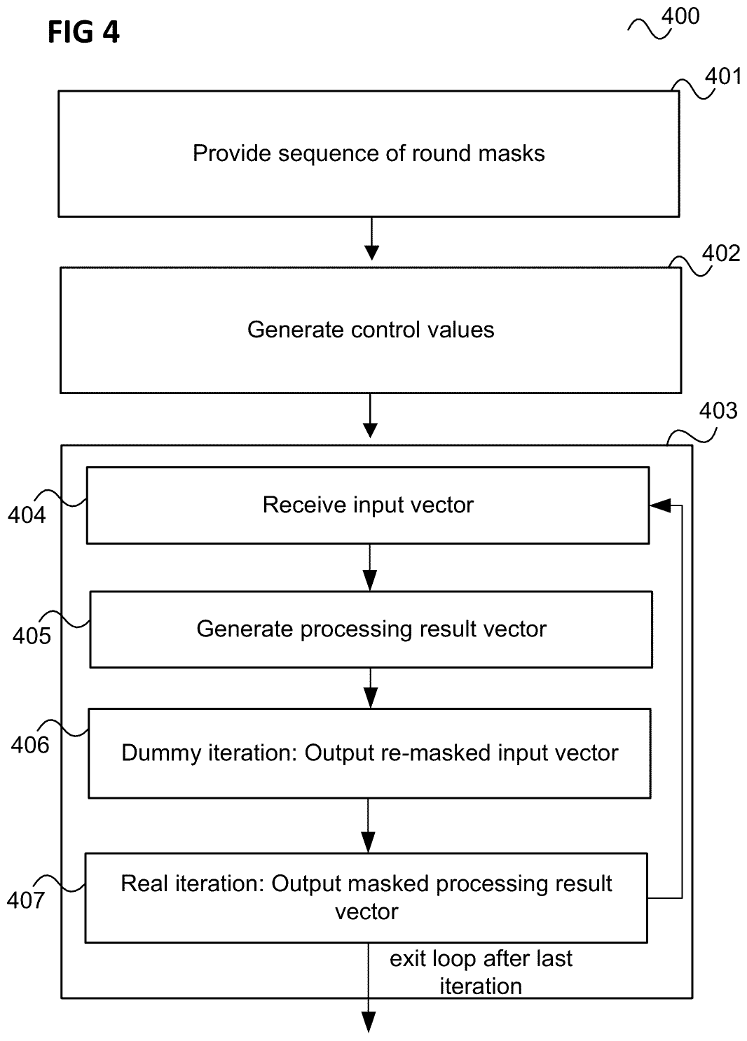

According to various embodiments, a method is carried out as illustrated in FIG. 4.

FIG. 4 shows a flow diagram 400 illustrating a method for processing secret data.

In 401, a sequence of round masks is provided (e.g., generated), wherein each round mask of the sequence of round masks is associated with a respective iteration of a sequence of iterations (e.g., until a maximum number of iterations has been reached).

In 402, a sequence of control values is generated, wherein each control value of the sequence of control values is associated with a respective iteration of the sequence of iterations and indicates, for the respective iteration, whether the iteration is a real iteration or a dummy iteration.

In 403, a vector of values is processed in the sequence of iterations, wherein each iteration comprises
receiving a respective input vector in 404,
generating a processing result vector in 405 by applying a predefined processing algorithm to the input vector; and
in reaction to that the control value associated with the iteration indicates that the iteration is a dummy iteration, outputting, in 406, as output vector of the iteration (to be used as input vector for the next iteration unless it was the last iteration), the input vector re-masked with the round mask associated with the next iteration of the sequence of iterations; and
in reaction to the control value associated with the iteration indicating that the iteration is a real iteration, in 407, generating a masked processing result vector by masking the processing result vector with the round mask associated with the next iteration and outputting the masked processing result vector as output vector of the iteration (to be used as input vector for the next iteration unless it was the last iteration).

It should be noted that the above processing does not need to be performed strictly in the indicated order but may also overlap or be carried out in an alternating manner. For example, it is not necessary that the round masks and the control values have all been completely generated when the iterations start.

Various examples are described in the following:

Example 1 is a data processing device as described with reference to FIG. 3.

Example 2 is the data processing device of example 1, wherein the processing algorithm takes an input mask generated by the round mask generator or another mask generator into account when processing the input vector which is supplied to it along with the input vector.

Example 3 is the data processing device of example 2, wherein the processing algorithm processes the input vector by treating the input vector as a vector masked by the input mask.

Example 4 is the data processing device of example 2 or 3, wherein the processor is configured to, in reaction to the value of the sequence of values indicating that the iteration is a real operation, generate the processing result vector by applying the processing algorithm to the input vector, wherein it supplies the round mask associated with the iteration to the processing algorithm as input mask.

Example 5 is the data processing device of any one of examples 2 to 4, wherein the processor is configured to, in reaction to the value of the sequence of values indicating that the iteration is a dummy operation, generate the processing result vector by applying the processing algorithm to the input vector, wherein it supplies a mask different from the round mask associated with the iteration to the processing algorithm as input mask.

Example 6 is the data processing device of example 5, comprising a dummy mask generator configured to generate a sequence of dummy masks, wherein each dummy mask of the sequence of dummy masks is associated with a respective iteration of the sequence of iterations and wherein the mask different from the round mask associated with the iteration is the dummy mask of the sequence of dummy masks associated with the iteration.

Example 7 is the data processing device of any one of examples 1 to 6, wherein the processing algorithm includes permutating components of the input vector.

Example 8 is the data processing device of any one of examples 1 to 7, wherein the input vector includes at least a part of data to be hashed and the processing algorithm is a processing round of a hash algorithm.

Example 9 is the data processing device of any one of examples 1 to 8, wherein the processor is configured to provide, in each iteration, the round mask associated with the next iteration for the next iteration.

Example 10 is the data processing device of any one of examples 1 to 9, wherein the round mask generator is configured to provide the round masks in a compressed form and the processor is configured to, for each iteration, decompress the round mask associated with the iteration.

Example 11 is the data processing device of any one of examples 1 to 10, wherein the processor is configured to, in each dummy iteration, generate the input vector re-masked with the round mask associated with the next iteration by masking the input vector (which is masked with the round mask associated with the current iteration) with the difference between the round mask associated with the (current) iteration and the round mask associated with the next iteration.

Example 12 is a method for processing secret data as described with reference to FIG. 4.

It should be noted that examples described with reference to the data processing device are analogously valid for the method for processing secret data.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A data processing device, comprising:
a round mask generator circuit configured to provide a sequence of round masks, wherein each round mask of the sequence of round masks is associated with a respective iteration of a sequence of iterations;
a controller circuit configured to generate a sequence of control values, wherein each control value of the sequence of control values is associated with a respective iteration of the sequence of iterations and indicates, for the respective iteration, whether the iteration is a real iteration or a dummy iteration; and
a processor circuit, configured to process a vector of values in the sequence of iterations, wherein each iteration comprises
receiving a respective input vector;
generating a processing result vector by applying a predefined processing algorithm to the input vector; and
in reaction to the control value associated with the iteration indicating that the iteration is a dummy iteration, outputting, as an output vector of the iteration, the input vector re-masked with the round mask associated with the next iteration of the sequence of iterations; and
in reaction to that control value associated with the iteration indicating that the iteration is a real iteration, generating a masked processing result vector by masking the processing result vector with the round mask associated with the next iteration and outputting the masked processing result vector as the output vector of the iteration.

2. The data processing device of claim 1, wherein the processing algorithm takes an input mask generated by the round mask generator or another mask generator into account when processing the input vector supplied to it along with the input vector.

3. The data processing device of claim 2, wherein the processing algorithm processes the input vector by treating the input vector as a vector masked by the input mask.

4. The data processing device of claim 2, wherein the processor circuit is configured to, in reaction to the value of the sequence of values indicating that the iteration is a real operation, generate the processing result vector by applying the processing algorithm to the input vector, wherein the processor circuit is configured to supply the round mask associated with the iteration to the processing algorithm as input mask.

5. The data processing device of claim 2, wherein the processor circuit is configured to, in reaction to the value of the sequence of values indicating that the iteration is a dummy operation, generate the processing result vector by applying the processing algorithm to the input vector, wherein the processor circuit is configured to supply a mask different from the round mask associated with the iteration to the processing algorithm as input mask.

6. The data processing device of claim 5, comprising a dummy mask generator circuit configured to generate a sequence of dummy masks, wherein each dummy mask of the sequence of dummy masks is associated with a respective iteration of the sequence of iterations and wherein the mask different from the round mask associated with the iteration is the dummy mask of the sequence of dummy masks associated with the iteration.

7. The data processing device of claim 1, wherein the processing algorithm includes permutating components of the input vector.

8. The data processing device of claim 1, wherein the input vector includes at least a part of data to be hashed and the processing algorithm is a processing round of a hash algorithm.

9. The data processing device of claim 1, wherein the processor circuit is configured to provide, in each iteration, the round mask associated with the next iteration for the next iteration.

10. The data processing device of claim 1, wherein the round mask generator circuit is configured to provide the round masks in a compressed form and the processor circuit is configured to, for each iteration, decompress the round mask associated with the iteration.

11. The data processing device of claim 1, wherein the processor circuit is configured to, in each dummy iteration, generate the input vector re-masked with the round mask associated with the next iteration by masking the input vector with the difference between the round mask associated with the iteration and the round mask associated with the next iteration.

12. A method for processing secret data, comprising:
providing a sequence of round masks, wherein each round mask of the sequence of round masks is associated with a respective iteration of a sequence of iterations;
generating a sequence of control values, wherein each control value of the sequence of control values is associated with a respective iteration of the sequence of iterations and indicates, for the respective iteration, whether the iteration is a real iteration or a dummy iteration; and
processing a vector of values in the sequence of iterations, wherein each iteration comprises
receiving a respective input vector;
generating a processing result vector by applying a predefined processing algorithm to the input vector; and
for each iteration for which the control value associated with the iteration indicates that the iteration is a dummy iteration, outputting, as an output vector of the iteration, the input vector re-masked with the round mask associated with the next iteration of the sequence of iterations; and
for each iteration for which the control value associated with the iteration indicates that the iteration is a real iteration, generating a masked processing result vector by masking the processing result vector with the round mask associated with the next iteration and outputting the masked processing result vector as the output vector of the iteration.

13. The method of claim 12, comprising taking an input mask generated by the round mask generator or another mask generator into account when processing the input vector supplied to it along with the input vector.

14. The method of claim 13, comprising processing the input vector by treating the input vector as a vector masked by the input mask.

15. The method of claim 13, further comprising, for each iteration for which the value of the sequence of values indicates that the iteration is a real operation, generating the processing result vector by applying the processing algorithm to the input vector, using the round mask associated with the iteration as input mask.

16. The method of claim 13, further comprising, for each iteration for which the value of the sequence of values indicating that the iteration is a dummy operation, generating the processing result vector by applying the processing algorithm to the input vector, using a mask different from the round mask associated with the iteration as input mask.

17. The method of claim 16, further comprising generating a sequence of dummy masks, wherein each dummy mask of the sequence of dummy masks is associated with a respective iteration of the sequence of iterations and wherein the mask different from the round mask associated with the iteration is the dummy mask of the sequence of dummy masks associated with the iteration.

18. The method of claim 12, further comprising permutating components of the input vector.

19. The method of claim 12, wherein the input vector includes at least a part of data to be hashed and the processing algorithm is a processing round of a hash algorithm.

20. The method of claim 12, further comprising providing, in each iteration, the round mask associated with the next iteration for the next iteration.
